(19) United States
(12) Patent Application Publication
(10) Pub. No.: US 2002/0089726 A1
(43) Pub. Date: Jul. 11, 2002

(54) System and method for wavelength modulated free space optical communication

(76) Inventors: Zhan He, Bedford Hills, NY (US); Sadeg M. Faris, Pleasantville, NY (US)

Correspondence Address: Richard L. Sampson, SAMPSON & ASSOCIATES, P.C., 50 Congress Street, Boston, MA, 02109, US

(21) Appl. No.: 09/896,508

(22) Filed: Jun. 29, 2001

Related U.S. Application Data
(60) Provisional application No. 60/219,098, filed on Jul. 18, 2000.

(51) Int. Cl. H04B 10/00

(52) U.S. Cl. 359/172; 359/154

(57) ABSTRACT

A system and method is provided for free-space optical communication in which information is encoded on at least two discrete optical carrier signals. The system includes a transmitter configured to encode information into at least two optical carrier signals and a receiver configured to receive and decode the information from the at least two optical carrier signals.

### BACKGROUND OF THE INVENTION

(1) Field of the Invention

The present invention generally relates to optical communications, and more particularly to high bandwidth, wireless optical communications.

(2) Background Information

The advent of Internet multimedia applications such as Internet video conferencing and downloadable digital video has substantially increased communication bandwidth requirements. As a result, interest in optical fiber-based communication, particularly in dense wavelength division multiplexing (DWDM) technology, has increased significantly in recent years (see for example U.S. Pat. No. 6,043,914 to Cook et al., which is fully incorporated herein by reference). While fiber optic communication provides greatly increased bandwidths as compared to conventional copper wire technology, the bandwidth achievable through the use of optical fibers is generally not considered to be sufficiently large to meet projected bandwidth demand required by future generation video applications. The bandwidth achievable by optical fiber communications tends to be limited by the narrow wavelength band in which optical fibers have acceptably low attenuation and/or dispersion. In typical commercial optical fibers, there are two relatively narrow wavelength windows (i.e. bands) at which the fiber material offers minimal attenuation, one centered around approximately 1310 nm and the other centered around approximately 1550 nm. Even with advanced DWDM technology, the number of achievable data channels, and therefore the achievable bandwidth, is relatively low. Further, optical fiber technology tends to be disadvantageous in that it requires the relatively expensive and time-consuming installation of optical fiber networks.

Wireless (also referred to as fiberless) optical communication may offer one potential solution to the above-described limitations of optical fiber. Wireless communication in the radio frequency (RF) range is relatively convenient and inexpensive, but has a limited bandwidth owing to the low frequency of RF radiation. In addition, wireless communication (typically using microwave radiation) is well known in satellite communications (both satellite-to-satellite and satellite-to-earth). More recently, there has been significant interest in developing systems for broader bandwidth, fiberless optical communication.

For example, Terabeam Networks®, Inc. (2300 Seventh Ave., Seattle, Wash.), Airfiber®, Inc. (16510 Via Esprillo, San Diego, Calif.), Lightpointe® Communications, Inc. (10140 Barnes Canyon Rd., San Diego, Calif.), and Oraccess, Inc. (17 Shmidmann St. Briei Brak 51429 ISRAEL) provide a “free space optics” (FSO), fiberless solution to the well known “last-mile bottleneck” to a user's premises. These commercial systems, however, typically transfer standard fiber optic-based technology into FSO and therefore tend to be limited by fiber optic bandwidth constraints. Terabeam Networks®, for example, offers a IGbit/sec FSO system operating at a wavelength of approximately 1550 nm. Likewise, Durant et al. in U.S. Pat. No. 6,016,212 (which is fully incorporated herein by reference) disclose a free space wavelength division multiplexing system operable in a relatively narrow wavelength range around 1550 nm.

In addition to operating in a relatively narrow bandwidth range, the above referenced technologies are also potentially disadvantageous in that they rely on standard amplitude modulation (AM) encoding techniques. As a result, these technologies may be sensitive to changes in weather conditions (e.g. wind, fog, rain or snow) that result in variations in optical intensity and may cause data loss or even data interruption. For example, in digital optical communication, light having a relatively high intensity commonly corresponds to a logical ‘1’ while light having a relatively low intensity commonly corresponds to a logical ‘0’. Optical intensity variations (e.g., caused by weather changes) may result in data loss (e.g., missed or erroneous bits) in the event the light intensity is not sufficiently high to register a logical ‘1’, or in the event background ‘noise’ is intense enough to obscure the logical ‘0’ and erroneously register a ‘1’ instead.

Therefore, there exists a need for an improved fiberless, optical communication system and method that overcomes at least one of the aforementioned difficulties.

### SUMMARY OF THE INVENTION

In one aspect, the present invention includes a free-space optical communication system including a transmitter configured to encode and transmit over free-space, information into at least two discrete optical carrier signals. A receiver is configured to receive and decode the information from the discrete optical carrier signals. In one variation, the system of this aspect communicates a logical 1 by transmitting a high amplitude optical pulse at a first carrier wavelength and communicates a logical 0 by transmitting a high amplitude optical pulse at a second carrier wavelength.

In another aspect, this invention includes a wavelength modulated optical communication based fiberless optical communication system. The system includes multiple transmitters, each configured to encode information into at least two discrete optical carrier signals, and includes multiple receivers each configured to receive and decode the information from the at least two discrete optical carrier signals. The system further includes multiple user ports, each including at least one of the multiple receivers, multiple hubs, each configured for transmitting and receiving data with at least two of the multiple user ports, and multiple repeaters each configured to receive, amplify, and route the optical signal to at least one member of the group consisting of other repeaters, hubs, and user ports.

In yet another aspect, this invention includes a method for free space communication of information. The method includes (i) encoding the information into at least two discrete optical carrier signals, (ii) transmitting the information, (iii) receiving the information, and (iv) decoding the information from the at least two discrete carrier wavelengths. In one variation of this aspect, the method further includes multiplexing the at least two optical carrier signals into a single beam and demultiplexing the single beam into multiple signals, each corresponding to a discrete carrier signal.

### BRIEF DESCRIPTION OF THE DRAWINGS

FIG. 1 is a schematic representation of a system for wavelength modulated optical communication according to the principles of this invention;

FIG. 2 is representative plot of optical intensity versus time illustrating one embodiment of the method of the present invention;

FIG. 3 is a representative plot of optical intensity versus wavelength illustrating one variation of the embodiment of FIG. 2;

FIG. 4 is a representative plot of optical intensity versus wavelength illustrating another variation of the embodiment of FIG. 2; and

FIG. 5 is a schematic representation of one embodiment of a wavelength modulated optical communication network of the present invention.

### DETAILED DESCRIPTION

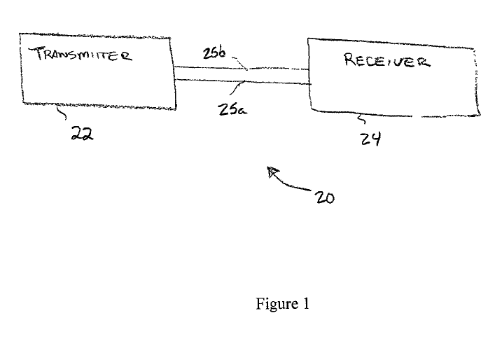

The present invention relates to a novel system and a method for wireless optical communication. An exemplary method of this invention, referred to herein as wavelength modulated optical communication (WMOC), includes encoding the information to be communicated on at least two discrete optical carrier signals, in which each carrier signal includes a modulated carrier wavelength. Referring to FIG. 1, a general block diagram of one embodiment of a system 20 according to the principles of this invention is illustrated. System 20 includes a transmitter 22 configured to transmit information encoded on at least two discrete optical carrier signals and a receiver 24 configured to receive and decode the transmitted information 25a, 25b. The transmitted optical signal 25a, 25b, may include two or more beams (e.g., one for each carrier signal) or may include a single beam wherein the optical carrier signals including the encoded information, are multiplexed.

The present invention is advantageous in that it provides for extremely high bandwidth wireless optical communications across a broad band of carrier wavelengths (typically in the range from about 300 to about 10,000 nm). Further, this invention may make use of conventional DWDM technology and may provide for a large number of broadband data transporting channels (e.g. 100 or more). Further still, this invention provides for improved stability and data reliability in adverse weather conditions such as wind, fog, rain and/or snow. Furthermore, this invention may provide for highly secure data transmission and may also provide a solution for the well-known “last-mile bottleneck.” Yet still further, this invention is advantageous in that it is compatible with conventional amplitude modulation optical communication.

As stated above, the method of the present invention includes encoding information on at least two discrete optical carrier signals, in which each carrier signal includes a modulated carrier wavelength that encodes a portion of a data stream (e.g., a bit stream). This is in contrast to conventional frequency shift keying (FSK) optical communication (see for example U.S. Pat. No. 4,564,946 to Olsson et al., U.S. Pat. No. 4,814,717 to Hooijmans, and U.S. Pat. No. 4,984,297 to Manome) in which information is transmitted by frequency shifting a continuous and optically coherent optical signal.

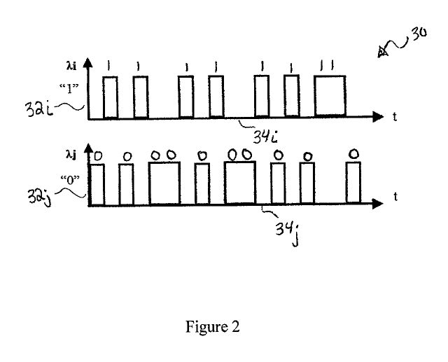

Referring now to FIG. 2, a representation of one embodiment 30 of the method of the present invention for encoding information in WMOC is illustrated. FIG. 2 is a representative plot of optical intensity on the ordinate axis 32i, 32j and time on the abscissa axis 34i, 34j for wavelengths λi and λj, respectively. In embodiment 30, one wavelength, λi, encodes a logical ‘1’ while the other wavelength, λj, encodes a logical ‘0’. The combination of the two wavelengths typically includes the entirety of the digital information. Wavelengths λi and λj are typically transmitted in two parallel, simultaneous beams and received at two mutually distinct detectors. Upon receiving the beams, the optical signals are decoded to produce a binary data stream. In embodiment 30, a logical ‘0’ is received when λi has a relatively high intensity and λj has a relatively low intensity. Conversely, a logical ‘1’ is received when λi has a relatively low intensity and λj has a relatively high intensity. In applications requiring high accuracy and reliability, the above method, in which a high intensity signal is required to register both a logical ‘1’ and a logical ‘0’, is advantageous in that it may prevent errors associated with background noise obscuring a conventional low (e.g., zero) intensity signal portion corresponding to a ‘0’ (e.g., in Single Side Band communication). The artisan of ordinary skill in the art will readily recognize that the carrier wavelengths λi and λj may be multiplexed into a single beam by the transmitting device and demultiplexed into its individual carrier wavelengths by a receiving device. Moreover, the skilled artisan will also recognize that substantially any modulation technique, such as conventional Pulse Code Modulation (PCM) or the like, may be used to encode digital information into carrier wavelengths λi and λj, without departing from the spirit and scope of the present invention.

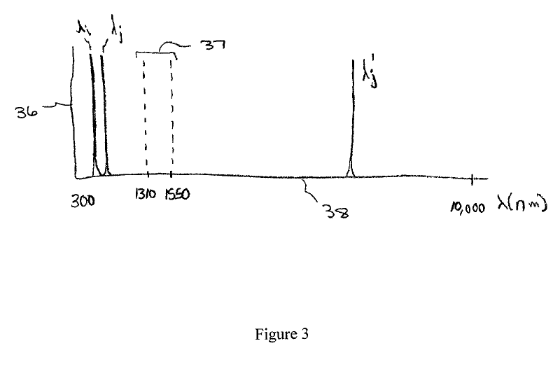

As shown in FIG. 3, which is a representative plot of amplitude 36 versus wavelength 38, the method of this invention is not restricted to utilizing infrared (IR) wavelengths 37 (e.g., approximately 1310 or 1550 nanometers), which, as mentioned hereinabove, are used in conventional fiber optic technology. Instead, the wavelengths used in the present invention may range from about 300 to more than about 10,000 nanometers. Also, as shown in FIG. 3, the carrier wavelengths may be relatively similar in magnitude (such as λi and λj of which (λi−λj)/(λi+λj)<0.2) or may substantially differ in magnitude (such as λi and λj′ in which (λi−λj′)/(λi+λj′)>1). For example, in one embodiment, the difference between first and second carrier wavelengths, λi and λj, may be less than 100 nanometers. In another embodiment, the difference between first and second carrier wavelengths, λi and λj′, may be greater than 1000 nanometers.

Since the potential wavelength (i.e., carrier wavelength) range is relatively large (approximately 300 to 10,000 nanometers as described above), multiple data channels, each having relatively high bandwidth (e.g., each having a bandwidth of 100's of gigahertz or more), may be employed. The term “bandwidth” is used herein consistently with its conventional dictionary definition, to refer to the difference between the frequency limits of a frequency band containing the useful frequency components of a signal. In conventional optical (or other electromagnetic wave) communication, the term “channel” refers to the frequency band around a carrier wavelength. As used herein, with respect to aspects of the present invention, each “data channel” includes at least two such channels or frequency bands, including one channel or frequency band around each discrete carrier wavelength. For example, in embodiments of the present invention employing two carrier wavelengths λi and λj, the data channel includes a 100 gigahertz frequency band around each of the carrier wavelengths λi and λj for a total bandwidth of 200 gigahertz per data channel. The wide wavelength range available in free space also provides for a relatively large number of data channels (even those of relatively high bandwidth). Therefore, embodiments of the present invention may be used to provide fiberless optical communication employing a large number of high bandwidth data channels for terabit/sec communication. For example, in one embodiment, a system may include at least 32 data channels, each having a bandwidth of at least 200 gigahertz, to provide fiberless optical communication having a total bandwidth of 6.4 terahertz or greater, for providing terabit per second data rates.

Further, the present invention may be combined with conventional WDM or DWDM technology (or yet to be developed multiplexing and/or demultiplexing technology) to provide for extremely wide bandwidth and/or data rate communications. Transmitter 22 may include any of numerous well known multiplexing components (referred to herein as MUX) for multiplexing the optical carrier signals. Receiver 24 may including any of numerous well known demultiplexing components (referred to herein as DEMUX) for demultiplexing the optical carrier signals. Multiplexing and demultiplexing technologies are well known in the art and are, therefore, not discussed in detail herein. In one embodiment, the at least two discrete optical carrier signals, including the encoded information, may be multiplexed into a single optical beam. In another embodiment, including multiple data channels (as defined hereinabove), transmitter 24 may transmit two optical beams, in which the first carrier signals for each data channel (e.g., those corresponding to the logical 1's for each channel) are multiplexed into a first beam, and the second carrier wavelengths for each data channel (e.g., those corresponding to the logical 0's for each channel) are multiplexed into a second beam. In yet another embodiment including multiple data channels, transmitter 24 may multiplex the signals into a single beam.

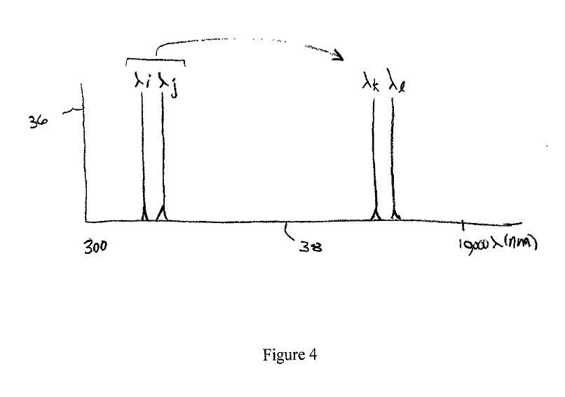

The present invention further provides for highly stable, fiberless optical communication, since the optical wavelengths used are relatively insensitive to adverse atmospheric conditions such as wind, fog, rain or snow. Moreover, alternate embodiments of the present invention may include switching (i.e. changing) the carrier wavelength pair to wavelengths that are less sensitive to particular weather conditions (e.g., the carrier wavelength pair may be switched to longer wavelengths). For example, as shown in FIG. 4, the carrier wavelengths may be changed from λi and λj to λk and λl upon the onset of adverse atmospheric conditions or even upon the forecast thereof.

Furthermore, the carrier wavelength pairs (λi and λj) may be changed randomly or following a programmable protocol to provide for increased security. The protocols may be previously determined or communicated to the receiver 24 (FIG. 1) in real time by control bits embedded in the data stream. This embodiment of the invented method provides a solution for potential security breaches, which have historically been a significant concern for wireless optical communication. It shall be understood that those of ordinary skill in the art will readily conceive of numerous schemes for changing the carrier wavelength pairs. For example, as shown in FIG. 4, the carrier wavelength pairs λi, λj and λk, λl may differ substantially in magnitude (i.e., λk−λi)/(λk+λi)>1). Carrier wavelength pairs λi, λj and λk, λl may also be relatively similar in magnitude (i.e., λk−λi)/(λk+λi)<0.5).

Referring again to FIG. 1, the system 20 of this invention may include any of a number of types of transmitter devices 22 and receiver devices 24. For example transmitter 22 may include a conventional wavelength modulator that utilizes a tunable laser, a tunable Fabry-Perot filter, a tunable Mach-Zehnder filter, an active Bragg grating wave guide, acousto-optical filters, or any other relatively high speed wavelength modulating device(s), including enhancements or alternatives thereto that may be developed in the future. Receiver 24 may include a passive device such as an interference filter, a DWDM interference filter, a wide-angle geometry (WAG) detector, a wavelength dispersive element, and the like. Receiver 24 may also include an active device such as a Fabry-Perot filter, a switchable diffraction grating, and the like.

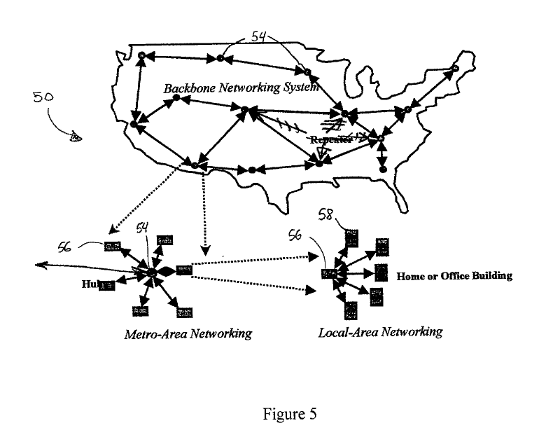

Turning now to FIG. 5, a high-level schematic of a WMOC-based fiberless optical communication network is shown. The WMOC system may include a point-topoint link or multiple point-to-point links (shown as repeaters 54) to build a national (or even global) fiberless networking system. Repeaters 54 may be used to transport WMOC data from city to city. In each metropolitan area, repeaters 54 may function as a center station for sending and/or receiving WMOC data from numerous hubs 56. Each hub 56 in turn may send and/or receive WMOC data from numerous user ports 58 (e.g., homes, offices and/or business dwellings). Moreover, system 50 may be combined fully or in part with conventional terrestrial and/or satellite microwave communication systems.

The modifications to the various aspects of the present invention described hereinabove are merely exemplary. It is understood that other modifications to the illustrative embodiments will readily occur to persons with ordinary skill in the art. All such modifications and variations are deemed to be within the scope and spirit of the present invention as defined by the accompanying claims.

What is claimed is:

1. A free-space optical communication system comprising:
a transmitter configured to encode and transmit over free-space, information in at least two discrete optical carrier signals; and
a receiver configured to receive and decode the information from said discrete optical carrier signals.

2. The system of claim 1 wherein said transmitter is configured to encode digital information into at least two discrete optical carrier signals.

3. The system of claim 2 wherein said discrete optical carrier signals include a first carrier signal and a second carrier signal;
said first carrier signal including information corresponding to logical 1's; and
said second carrier signal including information corresponding to logical 0's.

4. The system of claim 2 wherein said discrete optical carrier signals include a first carrier signal and a second carrier signal;
said transmitter being configured to communicate a logical 1 by transmitting a positive amplitude optical pulse at a first carrier wavelength and to communicate a logical 0 by transmitting a positive amplitude optical pulse at a second carrier wavelength.

5. The system of claim 1 wherein said transmitter is configured to transmit at least two distinct optical beams; each beam comprising at least one of said discrete optical carrier signals.

6. The system of claim 5 wherein said receiver is configured to receive at least two distinct beams, each beam comprising at least one of said discrete optical carrier signals.

7. The system of claim 1 wherein said transmitter comprises at least one multiplexer to multiplex said optical signals.

8. The system of claim 7 wherein said receiver comprises at least one demultiplexer to demultiplex said optical signals.

9. The system of claim 1 wherein each of said at least two discrete optical carrier signals comprises a carrier wavelength in the range of about 300 to about 10,000 nanometers.

10. The system of claim 9 wherein each of said at least two discrete optical carrier signals comprises a carrier wavelength in the range of about 300 to about 1,500 nanometers.

11. The system of claim 9 wherein each of said at least two discrete optical carrier signals comprises a carrier wavelength in the range of about 1,500 to about 10,000 nanometers.

12. The system of claim 9 wherein said discrete optical carrier signals comprise a first carrier wavelength and a second carrier wavelength, in which the difference between said first carrier wavelength and said second carrier wavelength is less than about 100 nanometers.

13. The system of claim 9 wherein said discrete optical carrier signals comprise a first carrier wavelength and a second carrier wavelength, in which the difference between said first carrier wavelength and said second carrier wavelength is greater than about 1000 nanometers.

14. The system of claim 1 wherein said transmitter is configured to change a carrier wavelength of each of said at least two discrete optical carrier signals.

15. The system of claim 14 wherein said transmitter is configured to change the carrier wavelength of each of said at least two discrete optical carrier signals from being within a range from about 300 to about 1,500 nanometers to being within a range from about 1,500 to about 10,000 nanometers.

16. The system of claim 14 wherein said transmitter is configured to change the carrier wavelength of each of said at least two discrete optical carrier signals from being within a range from about 1,500 to about 10,000 nanometers to being within a range from about 300 to about 1,500 nanometers.

17. The system of claim 14 wherein said transmitter is configured to change the carrier wavelength of each of said at least two discrete optical carrier signals in a random manner.

18. The system of claim 14 wherein said transmitter is configured to change the carrier wavelength of each of said at least two discrete optical carrier signals in a programmed manner.

19. The system of claim 14 wherein said transmitter is configured to embed control bits into at least one of said discrete optical carrier signals for communicating future changes in carrier wavelengths to said receiver.

20. The system of claim 14 wherein said receiver is configured to decode said control bits and to receive the changed optical carrier signals including changed carrier wavelengths.

21. The system of claim 1 wherein said transmitter comprises a member of the group consisting of a tunable laser, a tunable Fabry-Perot filter, a tunable Mach-Zehnder filter, an active Bragg grating wave guide, and an acousto-optical filter.

22. The system of claim 1 wherein said receiver comprises a member of the group consisting of an interference filter, a dense wavelength division multiplexing interference filter, a wide-angle geometry (WAG) detector, a wavelength dispersive element, a Fabry-Perot filter, and a switchable diffraction grating.

23. The system of claim 1 wherein said transmitter is configured to transmit data using multiple data channels, each of said data channels having first and second ones of said discrete optical carrier signals.

24. The system of claim 23 wherein each of said multiple data channels includes a bandwidth greater than about 200 gigahertz.

25. The system of claim 24 including at least 32 data channels and having a system bandwidth of greater than about 6.4 terahertz.

26. The system of claim 23 wherein said transmitter is configured to multiplex said multiple channels into a single beam.

27. The system of claim 23 wherein said transmitter is configured to multiplex said first ones of said carrier signals for each of said data channels into a first beam and said second ones of said carrier signals for each of said data channels into a second beam.

28. A wavelength modulated optical communication based fiberless optical communication system comprising:
multiple transmitters each configured to encode information into at least two discrete optical carrier signals;
multiple receivers each configured to receive and decode the information from said at least two discrete optical carrier signals;
multiple user ports, each including at least one of said multiple receivers; and
multiple hubs, each configured for transmitting and receiving data with at least two of said multiple user ports.
multiple repeaters each configured to receive, amplify, and route the optical signal to at least one member of the group consisting of other repeaters, hubs, and user ports.

29. A method for free space communication of information comprising:
encoding the information into at least two discrete optical carrier signals;
transmitting said encoded carrier signals;
receiving said encoded carrier signals; and
decoding the information from said carrier signals.

30. The method of claim 29 wherein said encoding comprises encoding digital information.

31. The method of claim 30 wherein said encoding digital information comprises encoding a high amplitude optical pulse at a first carrier wavelength to correspond to a logical 1, and encoding a high amplitude optical pulse at a second carrier wavelength to correspond to a logical 0.

32. The method of claim 29 further comprising:
multiplexing said at least two discrete optical carrier signals into a single beam; and
demultiplexing the single beam into said discrete optical carrier signals.

33. The method of claim 29 further comprising:
multiplexing a plurality of data channels into a single beam, each of said data channels having first and second ones of said discrete optical carrier signals; and
demultiplexing said single beam into said first and second ones of said discrete optical carrier signals.

34. The method of claim 29 further comprising:
multiplexing a plurality of data channels into first and second beams, each of said data channels having first and second ones of said discrete optical carrier signals, said first beam including said first optical carrier signals of each of said data channels, and said second beam including said second optical carrier signals of each of said multiple data channels; and
demultiplexing said first and second beams into said first and second optical carrier signals of said data channels.

35. The method of claim 32 wherein said multiplexing and said demultiplexing comprise dense wavelength division multiplexing.

36. The method of claim 29 wherein each of said at least two discrete optical carrier signals comprises a carrier wavelength in the range of about 300 to about 10,000 nanometers.

37. The method of claim 29 further comprising changing the carrier wavelength of each of said at least two discrete optical carrier signals to another wavelength.

38. The method of claim 37 wherein a first pair of carrier wavelengths, λi and λj, are changed to a second pair of carrier wavelengths, λk and λl, wherein (λk−λi)/(λk+λi)<0.5.

39. The method of claim 37 wherein a first pair of carrier wavelengths, λi and λj, are changed to a second pair of carrier wavelengths, λk and λl, wherein (λk−λi)/(λk+λi)>1.

40. The method of claim 37 wherein said changing comprises changing in a random manner.

41. The method of claim 37 wherein said changing comprises changing in a programmed manner.

42. The method of claim 37 wherein said encoding comprises embedding control bits in the information for communicating future changes in the carrier wavelengths to a receiver.
